(19) United States
(12) Patent Application Publication
(10) Pub. No.: US 2006/0061209 A1
(43) Pub. Date: Mar. 23, 2006

(54) Vehicle wheel rim

(76) Inventor: Ting-Fang Wang, Lu-Zhou City (TW)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/193,109

(22) Filed: Jul. 30, 2005

(30) Foreign Application Priority Data
Sep. 22, 2004 (TW) 093128709

(51) Int. Cl. B60B 3/10

(52) U.S. Cl. 301/64.704

(57) ABSTRACT

A vehicle wheel rim includes a wheel rim body having a tubular wall formed by deep drawing and having two opposite ends, and an annular protrusion formed as one piece with and projecting radially and inwardly from the tubular wall between the two ends. The annular protrusion has a first bent part which is bent inwardly from the tubular wall, and a second bent part which is bent outwardly from the first bent part. The first and second bent parts are flattened to abut each other. The annular protrusion further has a plurality of angularly spaced-apart through holes that extend through the first and second bent parts.

### CROSS-REFERENCE TO RELATED APPLICATION

This application claims priority of Taiwanese Application No. 093128709, filed on Sep. 22, 2004.

### BACKGROUND OF THE INVENTION

1. Field of the Invention

The invention relates to a wheel rim, more particularly to an aluminum alloy wheel rim for a vehicle.

2. Description of the Related Art

Referring to FIG. 1, a first conventional vehicle wheel rim 1 is made by first forming an elongated aluminum plate 11 (shown in phantom lines) by extrusion. The aluminum plate 11 is provided with a plurality of parallel ribs 12 (only two ribs 12 are shown) projecting integrally along the length thereof. The aluminum plate 11 then undergoes roll bending so as to form a tubular shape. Two ends of the aluminum plate 11 are subsequently welded together so as to form a wheel rim body 13, and the ribs 12 which are located inside the wheel rim body 13 are bored with a plurality of angularly spaced-apart holes 121 to facilitate fastening of a central disc 14 to the wheel rim body 13.

However, precision in the roundness of the wheel rim body 13 is not easily achieved during production. Further, since two ends of the aluminum plate 11 are connected together by a welding process, heat produced during the welding process degrades the material of the wheel rim 1 so that stress is concentrated in this area of connection during use of the wheel rim 1. This may lead to a dangerous situation. Hence, the first conventional wheel rim 1 is unsafe to use. Moreover, when a tire is mounted on the wheel rim 1, the welded ends of the aluminum plate 11 can cause air leakage in the tire as a result, for example, of the uneven surface introduced by the welds.

Referring to FIG. 2, a second conventional wheel rim 2 includes a left annular body 21, a right annular body 22, and a central disc 23. The left and right annular bodies 21, 22 are made by punching and drawing processes. The central disc 23 is clamped between the left and right annular bodies 21, 22, and is fastened therebetween through a plurality of screws 24. The second conventional wheel rim 2 has three components, i.e., the left and right annular bodies 21, 22 and the central disc 23. Hence, the second conventional wheel rim 2 has a relatively large number of components, thereby making manufacture of the second conventional wheel rim 2 complicated. Furthermore, a junction of the left and right annular bodies 21, 22 and the central disc 23 can cause air leakage in a tire mounted on the second conventional wheel rim 2.

Referring to FIG. 3, a third conventional wheel rim 3 includes a wheel rim body 31 and a central disc 32. The wheel rim body 31 is made as a single piece by a drawing process, and has an annular shoulder portion 311 formed in an inner face thereof. The central disc 32 is directly welded to the shoulder portion 311. Although the third conventional wheel rim 3 has a simple structure and is easy to make, heat produced during the welding process degrades the material of the wheel rim 3 to thereby result in the same aforementioned drawbacks of the first conventional wheel rim 1. Hence, the third conventional wheel rim 3 is also unsafe to use.

### SUMMARY OF THE INVENTION

Therefore, the object of the present invention is to provide a vehicle wheel rim that has a simple structure, that is easy to make, and that is safe to use.

According to this invention, a vehicle wheel rim comprises a wheel rim body having a tubular wall formed by deep drawing and having two opposite ends, and an annular protrusion formed as one piece with and projecting radially and inwardly from the tubular wall between the two ends. The annular protrusion has a first bent part which is bent inwardly from the tubular wall, and a second bent part which is bent outwardly from the first bent part. The first and second bent parts are flattened to abut each other. The annular protrusion further has a plurality of angularly spaced-apart through holes that extend through the first and second bent parts.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective of a first conventional wheel rim;

FIG. 2 is an exploded sectional view of a second conventional wheel rim;

FIG. 3 is a sectional view of a third conventional wheel rim;

FIG. 4 is an exploded perspective view of the preferred embodiment of a vehicle wheel rim according to the present invention;

FIG. 5 is a sectional view of the preferred embodiment; and

FIG. 6 illustrates the steps involved in making the vehicle wheel rim of the present invention.

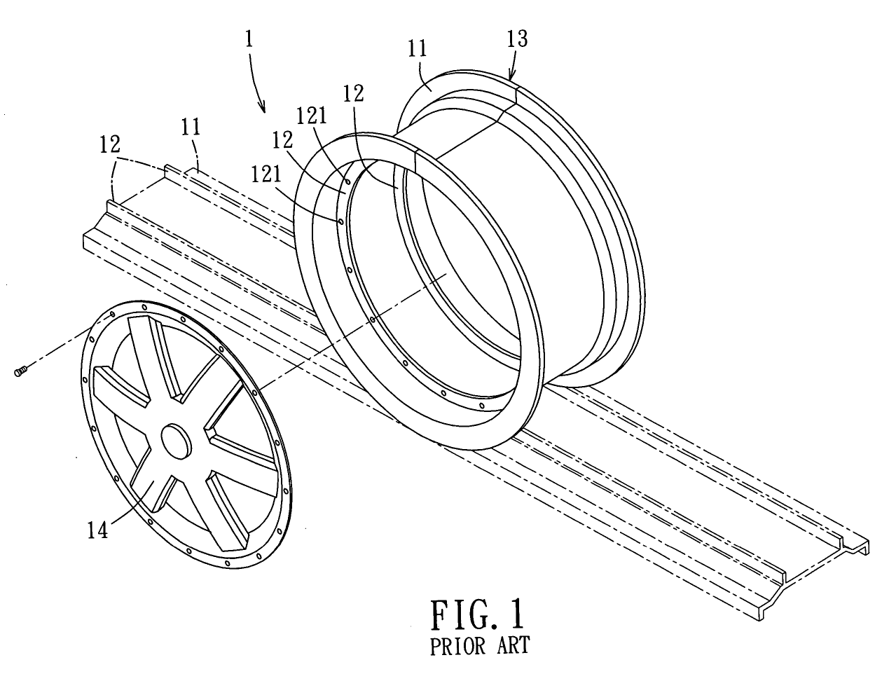

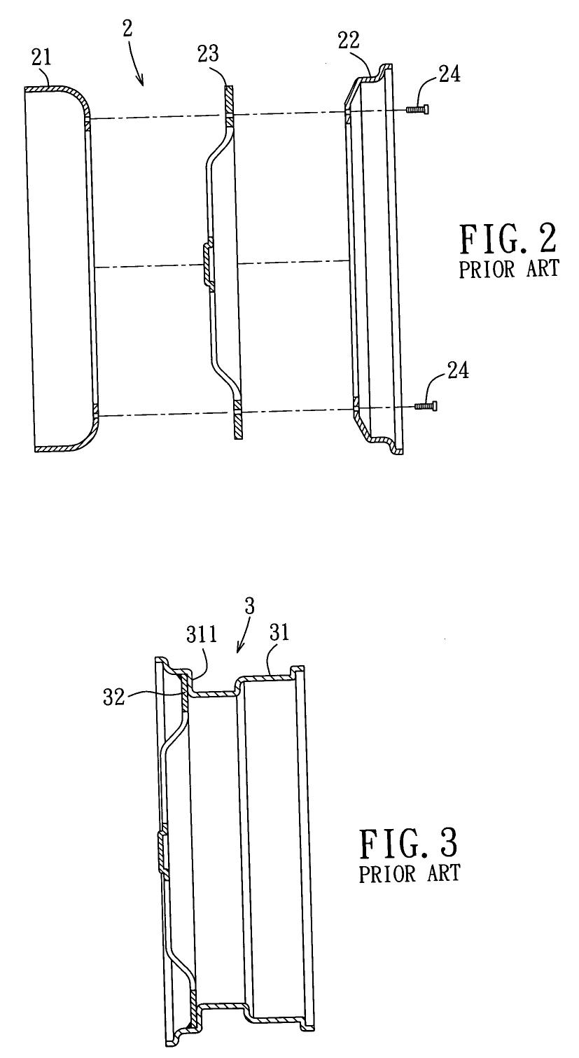

### DETAILED DESCRIPTION OF THE PREFERRED EMBODIMENT

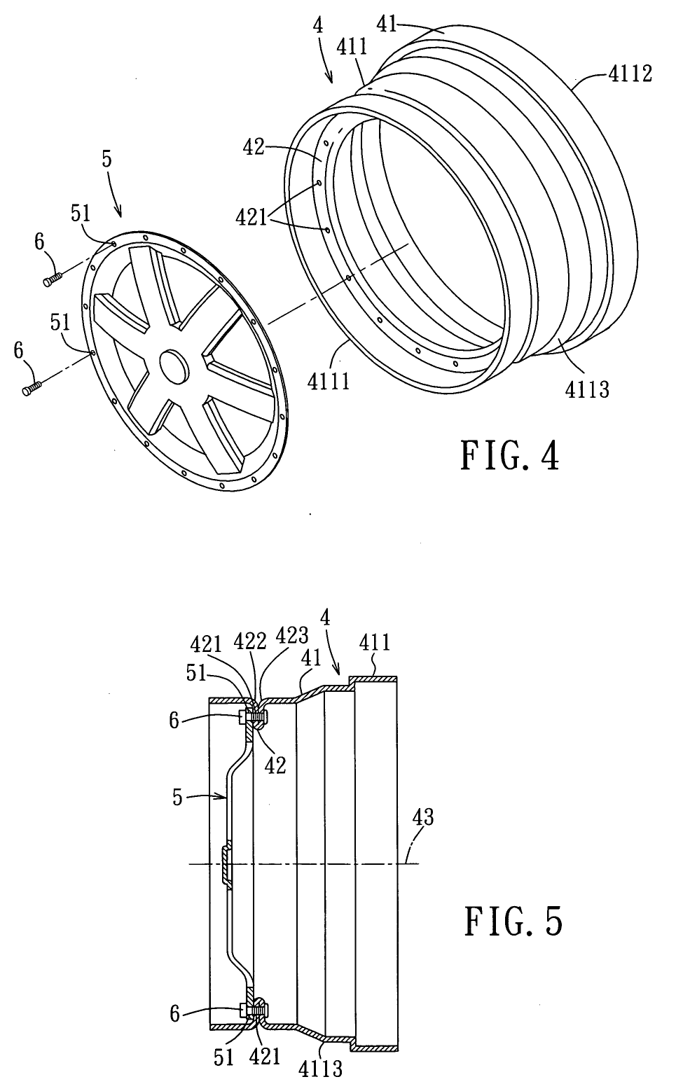

Referring to FIGS. 4 and 5, the preferred embodiment of a vehicle wheel rim 4 according to the present invention is shown to comprise a wheel rim body 41, a central disc 5, and a plurality of fastening units 6.

The wheel rim body 41 has a tubular wall 411 and an annular protrusion 42. The tubular wall 411 is made by deep drawing an aluminum alloy plate, and has opposite first and second ends 4111, 4112. The aluminum alloy plate is a lightweight and strong material that exhibits good extendibility. The annular protrusion 42 projects radially, inwardly and integrally from the tubular wall 411 between the first and second ends 4111, 4112, and has a plurality of angularly spaced-apart through holes 421. The annular protrusion 42 further has a first bent part 422 which is bent inwardly from the tubular wall 411 proximate to the first end 4111, and a second bent part 423 which is bent outwardly from the first bent part 422. The first and second bent parts 422, 423 are flattened so as to abut each other. The tubular wall 411 is formed with a plurality of stepped portions 4113 extending between the second end 4112 and the second bent part 423.

The central disc 5 is seated against the annular protrusion 42, and has a plurality of angularly spaced-apart through holes 51 that correspond to the through holes 421 in the annular protrusion 42.

Each of the fastening units 6 is configured as a screw or bolt that extends through a respective one of the through holes 51 and a corresponding one of the through holes 421 so as to fasten the central disc 5 to the annular protrusion 42.

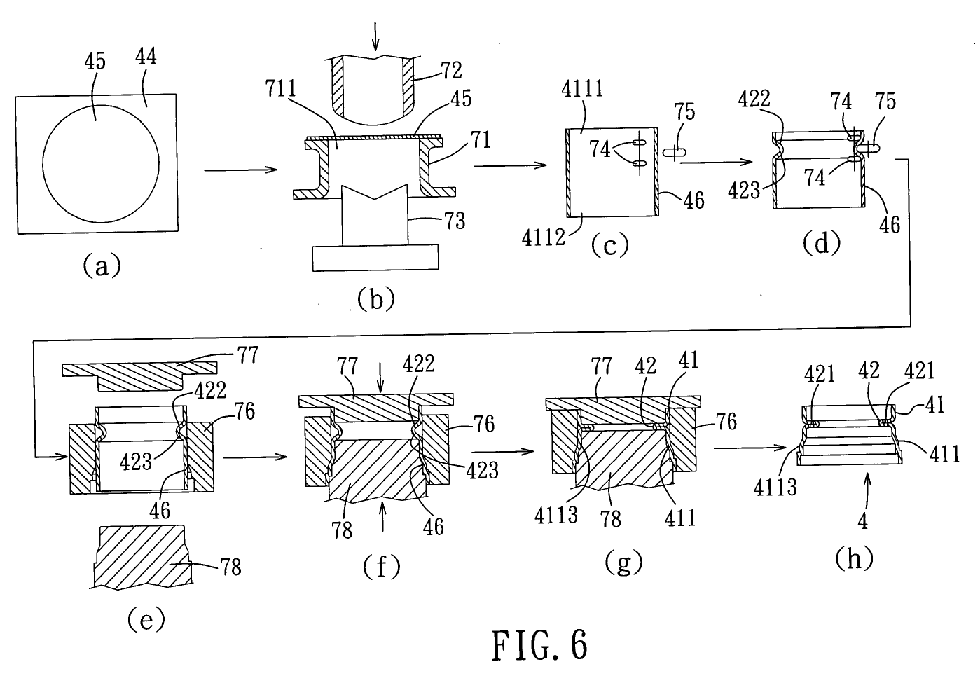

FIG. 6 illustrates the steps involved in making the vehicle wheel rim of the present invention, which may be summarized as follows:

In step (a), an aluminum alloy plate 44 is cut so as to form a circular plate 45. The circular plate 45 has a diameter of about 958 mm and a thickness of about 6-7 mm.

In step (b), the circular metal plate 45 undergoes a deep drawing process. In particular, the circular plate 45 is placed over an opening of a drawing die 71, and a punch 72 is moved downwardly so as to force the circular metal plate 45 into a cavity 711 of the drawing die 711, thereby forming a substantially cylindrical body with an upwardly extending opening. A cutting tool 73, which is disposed opposite to the punch 72, is simultaneously moved upward into the cavity 711 of the drawing die 71 so as to shear a central bottom portion of the cylindrical body, while the punch 72 is continuously moved downward, thereby forming the circular plate 45 into a substantially cylindrical blank 46 [see step (c)] having opposite first and second ends 4111, 4112 and a diameter of about 508 mm.

In steps (c) and (d), the cylindrical blank 46 is removed from the drawing die 71. Two inner rollers 74 are disposed at an inner side of the blank 46, and an outer roller 75 is disposed at an outer side of the blank 46 so that the blank is positioned between the inner and outer rollers 74, 75. The inner and outer rollers 74, 75 are activated so as to cooperatively press and bend the blank 46, thereby forming a first bent part 422 and a second bent part 423 in the blank 46. The first bent part 422 is bent inwardly from the blank 46 proximate to the first end 4111, whereas the second bent part 423 is bent outwardly from the first bent part 422.

In steps (e), (f) and (g), the blank 46 with the first and second bent parts 422, 423 is placed into a cavity of a mold 76. An upper press member 77 and a lower press member 78 are provided respectively on top and bottom portions of the mold 76. The upper and lower press members 77, 78 are activated so as to move simultaneously into the mold 76, thereby flattening the first and second bent parts 422, 423. Hence, the blank 46 is formed into a wheel rim body 41 with a tubular wall 411 (see FIGS. 4 and 5) having a folded annular protrusion 42 (see FIGS. 4 and 5) and a plurality of stepped portions 4113 extending between the second end 4112 and the annular protrusion 42.

In step (h), the wheel rim body 41 with the tubular wall 411 and the annular protrusion 42 is removed from the mold 76. The annular protrusion 42 is then bored with a plurality of angularly spaced-apart through holes 421.

From the aforementioned description, the process of making the vehicle wheel rim 4 of the present invention involves forming the blank 46 through the deep drawing process, after which the inner and outer rollers 74, 75 are used to form the first and second bent parts 422, 423 in the blank 46. Subsequently, through the mold 76 and the upper and lower press members 77, 78, the blank 46 is formed into the wheel rim body 41 with the tubular wall 411 and the annular protrusion 42. The annular protrusion 42 is then bored with the through holes 421 to facilitate fastening of the central disc 5 to the annular protrusion 42 of the wheel rim body 41. Hence, the process is very simple. In addition, through the above-described fastening method, the drawbacks associated with using the welding method are avoided. Further, the configuration of the annular protrusion 42 can enhance the strength of the wheel rim body 41, so that the vehicle wheel rim 4 of the present invention is safe to use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A vehicle wheel rim comprising:
a wheel rim body having a tubular wall formed by deep drawing and having two opposite ends, and an annular protrusion formed as one piece with and projecting radially and inwardly from said tubular wall between said two ends, said annular protrusion having a first bent part which is bent inwardly from said tubular wall, and a second bent part which is bent outwardly from said first bent part, said first and second bent parts being flattened to abut each other, said annular protrusion further having a plurality of angularly spaced-apart through holes that extend through said first and second bent parts.

2. The vehicle wheel rim of claim 1, further comprising a disc seated against said annular protrusion and having a plurality of angularly spaced-apart through holes that correspond to said through holes in said annular protrusion, and a plurality of fastening units respectively extending through said through holes in said disc and said annular protrusion for fastening said disc to said annular protrusion.
